(19) United States
(12) Patent Application Publication
(10) Pub. No.: US 2015/0280208 A1
(43) Pub. Date: Oct. 1, 2015

(54) METHOD AND APPARATUS FOR MANUFACTURING NEGATIVE ELECTRODE FOR LITHIUM-ION SECONDARY BATTERY, NEGATIVE ELECTRODE FOR LITHIUM-ION SECONDARY BATTERY, AND LITHIUM-ION SECONDARY BATTERY

(71) Applicant: Hitachi, Ltd., Tokyo (JP)

(72) Inventors: Naoki KIMURA, Tokyo (JP); Eiji SEKI, Tokyo (JP)

(73) Assignee: HITACHI, LTD., Tokyo (JP)

(21) Appl. No.: 14/626,697

(22) Filed: Feb. 19, 2015

(30) Foreign Application Priority Data
Mar. 26, 2014 (JP) 2014-063567

(51) Int. Cl. H01M 4/04; H01M 10/0525; H01M 4/62; H01M 4/38; H01M 4/139; H01M 4/13

(52) U.S. Cl. CPC H01M 4/0435; H01M 4/0404; H01M 4/0471; H01M 4/139; H01M 4/13; H01M 4/622; H01M 4/386; H01M 4/387; H01M 10/0525

(57) ABSTRACT

In manufacturing a negative electrode for a lithium-ion secondary battery, the negative electrode including a negative-electrode mixture layer including a negative-electrode active material and a binder containing at least one selected from a group consisting of a polyimide, a polyamide-imide and a polyamide, and a negative-electrode collector, the negative-electrode collector coated with a negative-electrode mixture slurry containing the binder is pressed by a hot-press roller which is heated to perform thermal curing and press together, such that the negative-electrode collector with the negative-electrode mixture slurry has a temperature of 200 to 400° C. Thus, mass-productivity of the negative electrode for the lithium-ion secondary battery is improved, and reduction in each of adhesiveness and adhesion uniformity of the binder as a component of the negative electrode is suppressed, and thereby direct-current resistance (DCR) of the lithium-ion secondary battery is decreased and a cycle life of the battery is improved.

### CLAIM OF PRIORITY

The present application claims priority from Japanese Patent application serial No. 2014-063567, filed on Mar. 26, 2014, the content of which is hereby incorporated by reference into this application.

### BACKGROUND OF THE INVENTION

1. Field of the Invention

The present invention relates to a method and an apparatus for manufacturing a negative electrode for a lithium-ion secondary battery, the negative electrode for the lithium-ion secondary battery, and the lithium-ion secondary battery.

2. Description of Related Art

Recently, electric vehicles (EV) have been developed by various automakers due to a problem of a global warming or a depletion of a fuel resource, and a lithium-ion secondary battery having a high energy density has been accordingly demanded as a power supply of the electric vehicle.

A negative-electrode active material containing silicon (Si) or tin (Sn) is expected to be a promising negative-electrode active material providing a high energy density. However, Si or Sn greatly varies in volume with charge and discharge; hence repeated charge-and-discharge leads to a break of a conductive network between active matrix particles. Thus, such a negative-electrode active material is relatively significant in a cycle degradation compared with other negative-electrode active materials.

Japanese Unexamined Patent Application Publication No. 2009-152037 (Patent Document 1) discloses a lithium-ion secondary battery in which a negative-electrode mixture layer contains a negative-electrode active material including an element that can be alloyed with Li, and a binder including at least one selected from a group consisting of a polyimide, a polyamide-imide and a polyamide, and a separator is adhesively in contact with at least one of the negative-electrode mixture layer and a positive-electrode mixture layer, in order to increase capacity and suppress volume variations of a negative electrode with charge and discharge.

Japanese Unexamined Patent Application Publication No. 2013-69681 (Patent Document 2) discloses a method of manufacturing a negative electrode for a lithium-ion secondary battery, the negative electrode including a laminate where a silicon-based active material layer containing a polyimide as a binder is provided on a current collector, the method including the steps of applying a silicon-based material dispersion onto a metal foil and then drying it to form a polyimide precursor layer containing the silicon-based material dispersed therein. Herein, drying temperature in the drying step is described to be preferably 150° C. or lower. It is further described that thermal curing is performed in the subsequent step, and temperature of the thermal curing is preferably 250 to 500° C. It is further described that the thermal curing is preferably performed under an inert gas atmosphere such as nitrogen atmosphere, but may be performed in an air atmosphere or in a vacuum.

### SUMMARY OF THE INVENTION

The present invention is characterized in that at least one selected from a group consisting of a polyimide, a polyamide-imide and a polyamide is used as a binder that is a component of a negative electrode for a lithium-ion secondary battery, and a hot-roll press step of performing a pressing by a roller heated to perform a thermal curing and a press together is performed on a negative-electrode collector coated with a negative-electrode mixture slurry containing the binder such that the negative-electrode collector with the negative-electrode mixture slurry has a temperature of 150 to 300° C.

According to the present invention, since the thermal curing and the press are performed together in the manufacturing process of the negative electrode for the lithium-ion secondary battery, the negative electrode can be thermally cured by a roll-to-roll process. Consequently, mass-productivity can be improved, and a manufacturing facility can be simplified. In addition, a region to be heated can be extremely decreased, making it possible to decrease energy necessary for manufacturing.

Furthermore, according to the present invention, it is possible to suppress reduction in each of adhesiveness and adhesion uniformity of a binder as a component of the negative electrode. This makes it possible to decrease a direct-current resistance (DCR) of the lithium-ion secondary battery and increase a cycle life of the battery.

### BRIEF DESCRIPTION OF THE DRAWINGS

FIG. 1 is a flowchart illustrating a fabrication process of an existing negative electrode for a lithium-ion secondary battery, the negative electrode including PVDF or SBR as a binder.

FIG. 2 is a flowchart illustrating a fabrication process of an existing negative electrode for a lithium-ion secondary battery, the negative electrode including a polyimide-based binder.

FIG. 3 is a flowchart illustrating a fabrication process of a negative electrode for a lithium-ion secondary battery according to the present invention, the negative electrode including a polyimide-based binder.

FIG. 4A is a schematic configuration view illustrating an example of a hot-roll press apparatus used for fabricating a negative electrode for a lithium-ion secondary battery according to the present invention.

FIG. 4B is a schematic configuration view illustrating another example of the hot-roll press apparatus used for fabricating the negative electrode for the lithium-ion secondary battery according to the present invention.

FIG. 5 is a schematic exploded perspective view illustrating an example of a laminated electrode group of the lithium-ion secondary battery.

FIG. 6 is a schematic exploded perspective view illustrating the laminated electrode group of FIG. 5 before being enclosed.

FIG. 7A is an expanded schematic sectional view illustrating an existing negative electrode for a lithium-ion secondary battery, the negative electrode including a polyimide-based binder.

FIG. 7B is an expanded schematic sectional view illustrating a negative electrode for a lithium-ion secondary battery according to the present invention.

### DETAILED DESCRIPTION OF THE PREFERRED EMBODIMENTS

The negative electrode including a binder including at least one selected from a group consisting of a polyimide, a polyamide-imide and a polyamide cannot be reduced in volume variations with expansion and contraction if the binder is not thermally cured at about 150 to 300° C.

When a high-temperature dryer is used for thermally curing each of such negative electrodes in a wound state, a production cost increases. In addition, temperature varies between the inside and the outside of the negative electrode wound in a roll, leading to a possibility of reduction in each of adhesiveness and adhesion uniformity of the binder.

Furthermore, when the negative electrode wound in the roll is thermally cured, the negative electrode must be unrolled into a flat sheet. This results in occurrence of cracks in the binder and causes separation, making it difficult to fabricate an electrode group.

An object of the present invention is to improve mass-productivity of the negative electrode for the lithium-ion secondary battery, and suppress the reduction in each of the adhesiveness and the adhesion uniformity of the binder as a component of the negative electrode, so that a direct-current resistance (DCR) of the lithium-ion secondary battery is decreased and a cycle life of the battery is improved.

First, a conventional example is explained hereinafter.

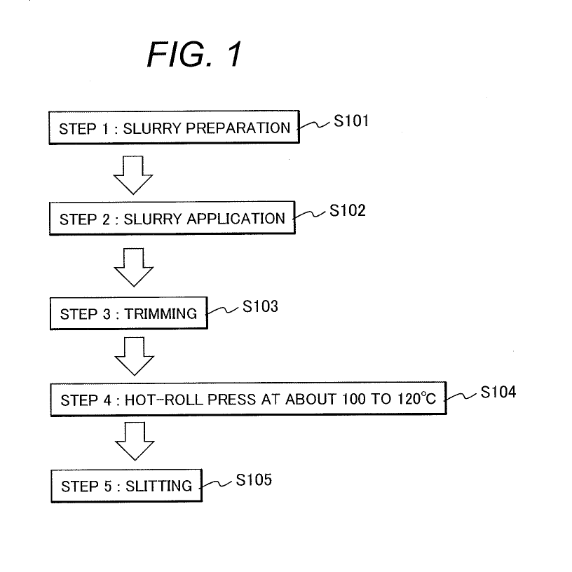

FIG. 1 illustrates steps of fabricating an existing negative electrode for a lithium-ion secondary battery, the negative electrode including a polyvinylidene fluoride (PVDF) or a styrene-butadiene rubber (SBR) as a binder. As illustrated in FIG. 1, the negative electrode which includes the PVDF or SBR as a binder and is thus not necessary to be thermally cured is fabricated in order of a slurry preparation (S101), a slurry application (S102), a trimming (S103), a hot-roll press at about 100 to 120° C. (S104), and a slitting (S105).

The slurry is mainly prepared by mixing an active material, the binder, a conductive aid and a solvent (S101). The slurry is applied onto a current collector (S102), and then trimming is performed (S103). The trimming (S103) is performed to provide an uncoated-portion having a certain width for welding of the current collector, or to prevent occurrence of creases due to stress exerted on a coating edge, the stress being caused by a short uncoated-portion width. The trimming step may not be performed if unnecessary. The hot-roll press S104 is performed to increase volume efficiency of the mixture in order to fill a battery container with a large amount of mixture. Press performance can be improved by heating the mixture to about 100 to 120° C. Subsequently, the slitting S105 is performed. The slitting is referred to adjusting the electrode width to facilitate lamination or winding for fabricating the electrode group.

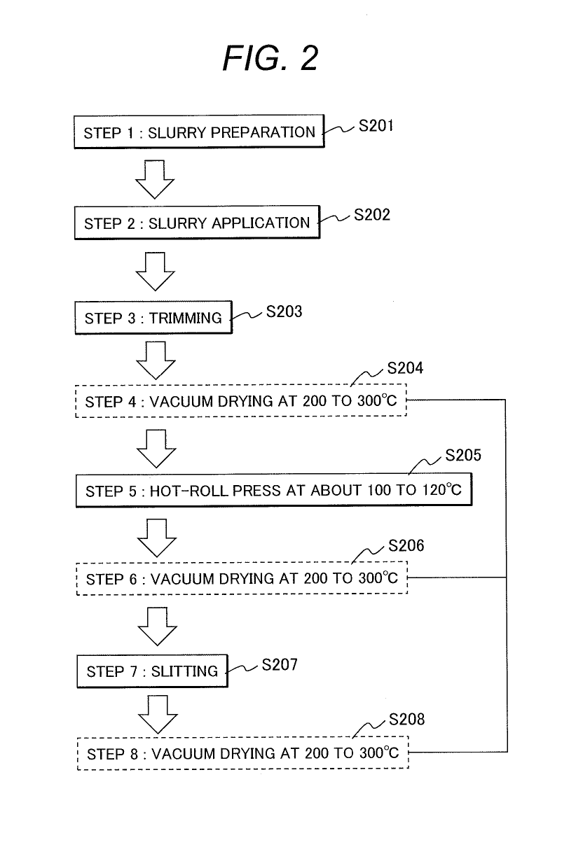

FIG. 2 illustrates steps of fabricating an existing negative electrode for a lithium-ion secondary battery, the negative electrode including a binder necessary to be thermally cured. The binder is a polyimide-based binder or the like. The polyimide-based refers to at least one selected from a group consisting of a polyimide, a polyamide-imide and a polyamide.

As illustrated in FIG. 2, in the fabrication of the existing negative electrode including the polyimide-based binder, a slurry preparation (S201), a slurry application (S202), and a trimming (S203) are performed as early steps. Such steps are performed in the same way as those in FIG. 1. Subsequently, a hot-roll press at about 100 to 120° C. (S205) and a slitting (S207) are performed, and thermal curing at 150 to 300° C. (S204, S206 or S208) is performed before or after the hot-roll press (S205), or before or after the slitting (S207). When a copper foil is used as the negative-electrode collector, the thermal curing must be performed under non-oxygen atmosphere, for example, in a vacuum, in order to prevent oxidation of copper. Herein, the copper foil may be formed of a copper alloy. If the negative electrode is thermally cured while being wound in a roll, the negative-electrode collector is separated from a negative-electrode mixture layer when the negative electrode is stretched into a flat sheet. In the case of the process illustrated in FIG. 2, the negative electrode must not be thermally cured while being wound in a roll in order to prevent such separation, and must be thermally cured after being formed into a flat sheet. This results in a low mass-productivity and a high cost. When an electrode group is a wound type, the mass production is extremely difficult. When an electrode group is a laminated type, the mass production is still low.

In the present invention, the thermal curing is performed at 150 to 300° C., preferably 200 to 300° C., in the hot-roll press step unlike in the existing techniques. In other words, the pressing and the thermal curing are performed together by pressing with a hot-press roller. The thermal curing temperature of 150 to 300° C. represents the temperature of the mixture. If temperature of the hot-press roller is not higher than such temperature, temperature of the negative-layer mixture layer is less than 150° C. Hence, the temperature of the hot-press roller used herein is desirably 200 to 400° C.

The thermal curing in the hot-roll press step is performed while a current collector coated with the negative-electrode mixture is shaped in a flat sheet. As a result, the negative-electrode mixture layer is not separated from the negative-electrode collector unlike the case of thermal curing of the negative electrode wound in a roll. The thermal curing is preferably performed under a non-oxygen atmosphere, for example, under nitrogen atmosphere or in a vacuum. For example, this makes it possible to prevent oxidation of copper in the case where a copper foil is used as the negative-electrode collector. The heated negative electrode is then cooled to 150° C. or lower before being exposed to the atmosphere, thereby the oxidation of the copper foil is suppressed. A cooling step may be provided after the hot-roll press step. The thermal curing may be performed by a roll-to-roll process in which negative electrodes supplied from the negative-electrode wound in a roll are successively subjected to a thermal curing, and then wound into a roll again.

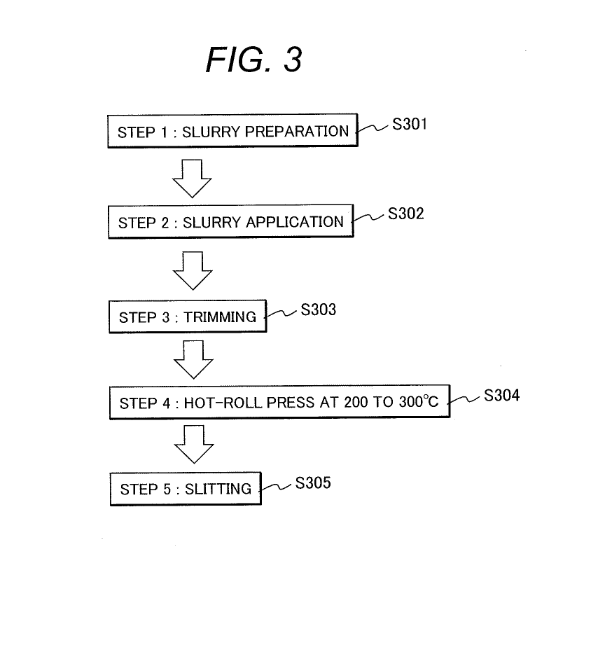

FIG. 3 is a flowchart illustrating an example of a fabrication process of a negative electrode of the present invention for a lithium-ion secondary battery, the negative electrode including a polyimide-based binder.

In FIG. 3, the negative electrode of the present invention is fabricated in order of a step of preparing a slurry to be applied onto the negative-electrode collector (S301), a step of applying the slurry (S302), a trimming step (S303), a step of performing a hot-roll press at a mixture temperature of 150 to 300° C. (S304), and a slitting step (S305).

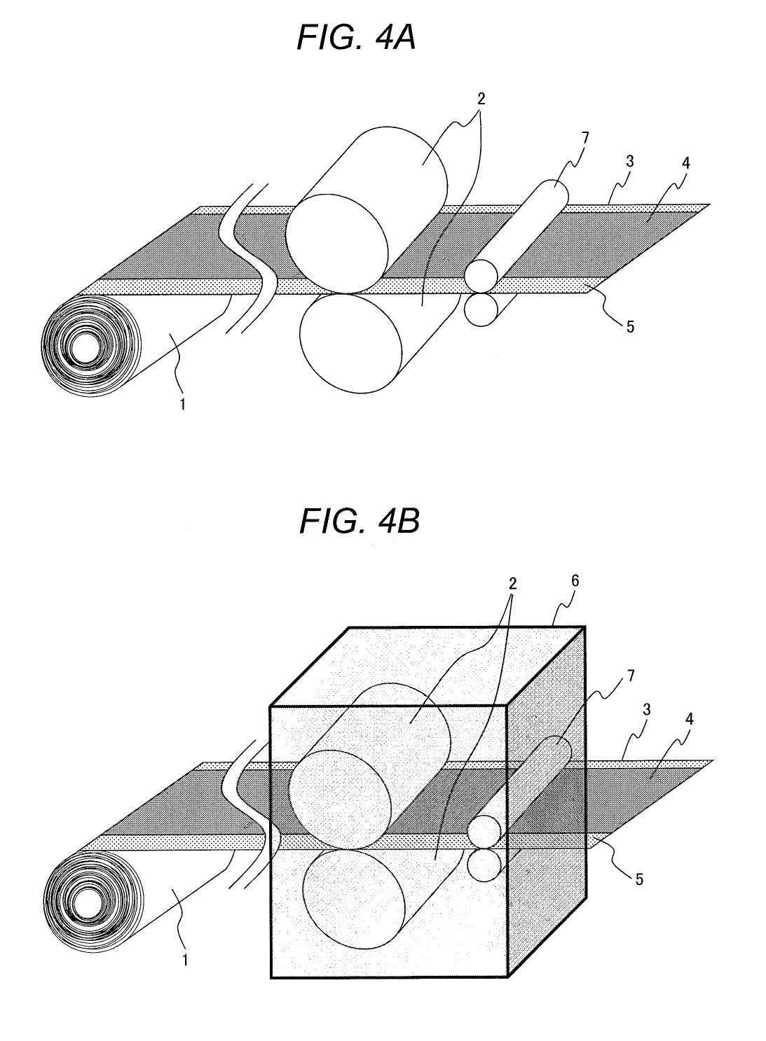

FIG. 4A illustrates an example of a hot-roll press apparatus for a lithium-ion secondary battery according to the present invention. In FIG. 4A, the hot-roll press apparatus includes hot-press rollers 2 and cooling rollers 7. A negative electrode 3 includes the negative-electrode collector being coated with a mixture 4 (slurry). An uncoated negative-electrode portion 5 is provided in either end of the negative electrode 3.

The negative electrode 3 is drawn out from the non-pressed negative electrode (negative-electrode roll 1) wound in a roll, and is then nipped between the two hot-press rollers 2 so as to be heated and pressed. At this time, the negative electrode 3 is heated to a temperature of 150 to 300° C. so that a thermal-curing reaction proceeds. The negative electrode 3 is instantly heated although it is in contact with the hot-press roller 2 for an extremely short time. The negative electrode 3 that has passed through a space between the two hot-press rollers 2 is then nipped between the two cooling rollers 7 so as to be cooled. Such processing is performed in the air atmosphere.

FIG. 4B illustrates a hot-roll press apparatus for the lithium-ion secondary battery according to another invention for performing the hot-roll press step under a non-oxygen atmosphere. FIG. 4B is different from FIG. 4A in that the hot-press rollers 2 and the cooling rollers 7 are placed under the non-oxygen atmosphere. The non-oxygen atmosphere is provided by enclosing the rollers as by a nitrogen substitution box 6 that is then filled with nitrogen or the like.

As described above, for example, when a copper foil is used as the negative-electrode collector, the processing with the hot-press roller 2 is desirably performed under non-oxygen atmosphere. For the copper foil, surface oxidation causes an increase in resistance (DCR). When the copper foil which has been subjected to a hot-roll press at 150 to 300° C. and is still hot is transferred into the air containing a large amount of oxygen, the surface of the copper foil is oxidized. To prevent this, the cooling rollers 7 are provided within the nitrogen substitution box 6.

As a result of an experiment, it has been found that the DCR is not increased when the temperature of the copper foil of the negative electrode 3 is controlled to be 150° C. or lower by the cooling rollers 7.

If the negative-electrode collector is configured of a stainless steel (SUS) foil, the problem of oxidation does not occur because the SUS foil has an oxide film on its surface. In this case, the nitrogen substitution box 6 is not necessary.

The negative electrode fabricated as described above has been used to fabricate a battery, and the DCR and cycle characteristics have been measured. As a result, it has been found that the DCR is decreased, and the cycle characteristics are improved. A variation in temperature is smaller in the thermal curing with the hot-roll press than in the thermal curing through heating the negative-electrode roll. It is considered that such a smaller variation in temperature results in uniform adhesion of the negative-electrode mixture, leading to improvement in battery characteristics.

Hereinafter, one embodiment according to the present invention is described in detail. The present invention however is not limited to the following embodiment. Although a laminated cell of a laminating type is described as a structure of the lithium-ion secondary battery, this is not limitative. When a negative electrode having a winding structure has been used in comparative example 1 described later, the negative electrode has been failed to be wound due to separation. Similar effects are provided by a cell enclosed in a metal can.

### <Lithium-Ion Secondary Battery>

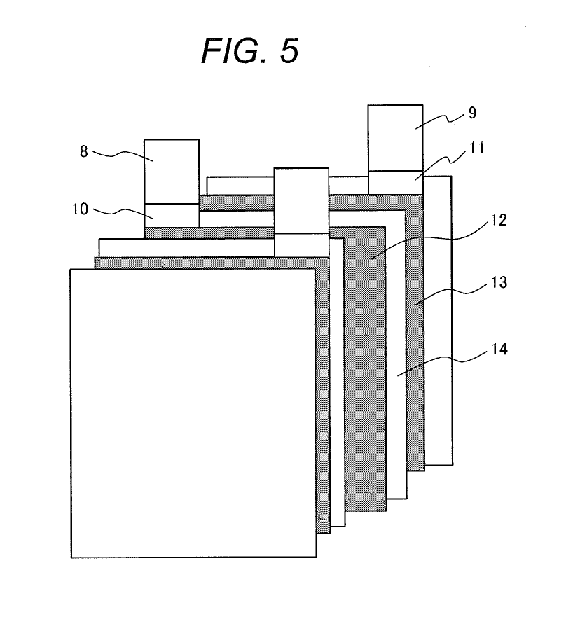

FIG. 5 is a schematic exploded perspective view illustrating an example of a laminated electrode group of the lithium-ion secondary battery.

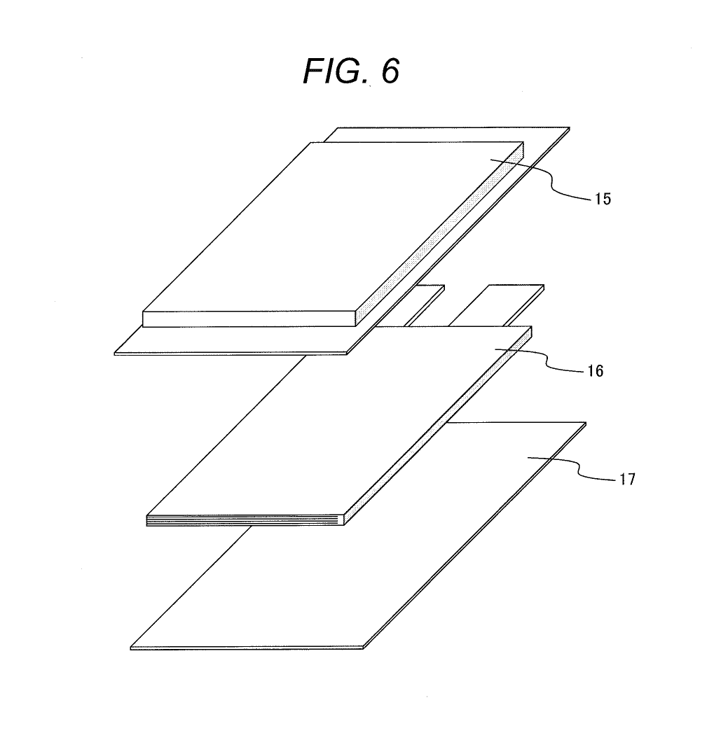

FIG. 6 is a schematic exploded perspective view illustrating the laminated electrode group of FIG. 5 before being enclosed.

In FIG. 6, a lithium-ion secondary battery of a laminate cell type has a structure in which a laminated electrode group 16 is sandwiched by two laminating films 15 and 17, and peripheries of the laminating films 15 and 17 are sealed by a thermal fusing. For example, the thermal fusing is performed through holding the peripheries at 175° C. for 10 seconds. The laminating film 15 is on a housing side, and the laminating film 17 is on a cap side.

As illustrated in FIG. 5, the laminated electrode group of the lithium-ion secondary battery includes sheet-like positive electrodes 12, sheet-like negative electrodes 13, and separators 14. Each separator 14 is disposed between each positive electrode 12 and each negative electrode 13. The laminated electrode group has a structure in which a plurality of sets are laminated, each set including the positive electrode 12, the negative electrode 13, and the separator 14.

The positive electrode 12 has a configuration where a positive-electrode mixture layer is provided by an application on either side of a positive-electrode collector (for example, an aluminum foil 15 μm thick). The negative electrode 13 has a configuration where a negative-electrode mixture layer is provided by an application on either side of a negative-electrode collector (for example, a copper or SUS foil 8 μm thick).

The positive electrode 12 has a positive-electrode terminal 8. The positive-electrode terminal 8 is a part of the positive-electrode collector, the part being protruded to the outside in a rectangularly extended manner. Also, the negative electrode 13 has a negative-electrode terminal 9. The negative-electrode terminal 9 is a part of the negative-electrode collector, the part being protruded to the outside in a rectangularly extended manner.

The positive electrode 12 and the negative electrode 13 have an uncoated positive-electrode portion 10 and an uncoated negative-electrode portion 11 that are not coated with the positive-electrode mixture layer and the negative-electrode mixture layer, respectively. In other words, the current collector is exposed in each of the uncoated positive-electrode portion 10 and the uncoated negative-electrode portion 11.

The respective uncoated positive-electrode portions 10 and uncoated negative-electrode portions 11 are bundled and welded to the positive-electrode terminal 8 and the negative-electrode terminal 9, respectively. The positive-electrode terminal 8 and the negative-electrode terminal 9 are components that electrically connect between an inside and an outside of the battery. A resistance welding or an ultrasonic welding is preferred as the welding method. A thermal fusing resin may be beforehand applied or attached for insulation onto a portion to be sealed of each of the positive-electrode terminal 8 and the negative-electrode terminal 9.

The laminated electrode group is sealed in such a manner that any of sides other than one side is first thermally fused to provide an electrolyte injection port, and the electrolyte is then injected, and then the remaining one side is sealed by the thermal fusing while being pressurized. Such a thermally fused portion on the remaining side is weaker than that on any of other sides, and has a function of a gas exhaust valve. A gas exhaust mechanism may also be provided by providing a small thickness portion in another region.

Each component is now described.

### (Negative Electrode)

### (1) Negative-Electrode Active Material

A negative-electrode active material containing silicon (Si) (also referred to an Si-based negative-electrode active material) is preferably used as the negative-electrode active material, but is not limited to it. As described before, the Si-based negative-electrode active material is a promising material providing high energy density. Volume variations with charge and discharge can be suppressed by using a binder described later.

Specifically, the Si-based negative-electrode active material preferably includes Si oxide represented by a chemical formula SiOₓ (0.5≦x≦1.5), or Si alloy containing Si and a dissimilar metal element (at least one of Al, Ni, Mn, Fe, Ti, etc.).

A mixture of Si and graphite (C) may be used as the negative-electrode active material. Mixing graphite with Si makes it possible to improve conductivity. In this case, the Si content is preferably 10 mass % or more of the total amount of the negative-electrode active material. When the content of silicon is less than 10 mass %, sufficient energy density is not provided.

In addition to the Si-based negative-electrode active material, a tin-based negative-electrode active material (an Sn-based negative-electrode active material) which includes Sn oxide, or Sn alloy containing Sn and a dissimilar metal element (at least one of Al, Ni, Mn, Fe, Ti, etc.), and a carbon-based negative-electrode active material (a C-based negative-electrode active material) which includes a graphite or an amorphous carbon can be used. The Sn-based negative-electrode active material is also relatively large in expansion and contraction with charge and discharge although not as large as the Si-based negative-electrode active material.

### (2) Binder

At least one selected from a group consisting of a polyimide (PI), a polyamide-imide (PAI) and a polyamide (PA) is used as the binder. Using such a binder makes it possible to suppress the expansion and contraction of the negative-electrode active material. Such binders may each be singly used, or may be mixedly used. Furthermore, such binders may each be mixed with another binder such as a polyvinylidene fluoride (PVDF) or a styrene-butadiene rubber (SBR).

### (Positive Electrode)

The positive electrode includes the positive-electrode collector and the positive-electrode mixture layer. The positive-electrode mixture layer includes the positive-electrode active material and the binder. Known materials may be used as the materials constituting the positive electrode without limitation.

For formation of the positive-electrode mixture layer, a solvent is mixed to the positive-electrode active material and the binder to prepare a positive-electrode mixture slurry. The slurry is applied onto the positive-electrode collector, and is then dried to fix the positive-electrode mixture layer.

For example, LiCo₂, LiNiO₂ and LiMn₂O₄ are preferred as the positive-electrode active material. In addition, LiMnO₃, LiMn₂O₃, LiMnO₂, Li₄Mn₅O₁₂, LiMn₂₋ₓMₓO₂ (where M is at least one selected from a group consisting of Co, Ni, Fe, Cr, Zn and Ti, and x is 0.01 to 0.2), Li₂Mn₃MO₈ (where M is at least one selected from a group consisting of Fe, Co, Ni, Cu and Zn), Li₁₋ₓAₓMn₂O₄ (where A is at least one selected from a group consisting of Mg, B, Al, Fe, Co, Ni, Cr, Zn and Ca, and x is 0.01 to 0.1), LiNi₁₋ₓMₓO₂ (where M is at least one selected from a group consisting of Co, Fe and Ga, and x is 0.01 to 0.2), LiFeO₂, Fe₂(SO₄)₃, LiCo₁₋ₓMₓO₂ (where M is at least one selected from a group consisting of Ni, Fe and Mn, and x is 0.01 to 0.2), LiNi₁₋ₓMₓO₂ (where M is at least one selected from a group consisting of Mn, Fe, Co, Al, Ga, Ca and Mg, and x is 0.01 to 0.2), Fe (MoO₄)₃, FeF₃, LiFePO₄ and LiMnPO₄ etc. can be used.

### (Separator)

Any material can be used as a separator as long as the material prevents a short circuit between the positive electrode and the negative electrode. For example, a polyolefin is preferably used. The polyolefin includes a polyethylene, a polypropylene and the like, which may be mixedly used. The polyolefin may be mixedly used with a heat resistant resin such as a polyamide, a polyamide-imide, a polyimide, a polysulfone, a polyether sulfone, a polyphenyl sulfone and a polyacrylonitrile.

The separator may be a resin such as a polyolefin coated with an inorganic filler layer on one or both of its sides. The inorganic filler layer desirably contains at least one of SiO₂, Al₂O₃, montmorillonite, mica, ZnO, TiO₂, BaTiO₃ and ZrO₂. Among them, SiO₂ or Al₂O₃ is most preferred in light of cost or performance.

### (Electrolyte)

The electrolyte includes a nonaqueous solvent and a supporting electrolyte salt. The nonaqueous solvent and the supporting electrolyte salt are each not particularly limited.

Examples of the nonaqueous solvent include ethylene carbonate, propylene carbonate, butylene carbonate, dimethyl carbonate, ethyl methyl carbonate, diethyl carbonate, γ-butyrolactone, γ-valerolactone, methyl acetate, ethyl acetate, methylpropionate, tetrahydrofuran, 2-methyltetrahydrofuran, 1,2-dimethoxyethane, 1-ethoxy-2-methoxyethane, 3-methyltetrahydrofuran, 1,2-dioxyane, 1,3-dioxyane, 1,4-dioxyane, 1,3-dioxolan, 2-methyl-1,3-dioxolan, and 4-methyl-1,3-dioxolan.

Examples of the supporting electrolyte salt include lithium salts such as LiPF₆, LiBF₄, LiClO₄ and LiN(C₂F₅SO₂)₂. In addition, known electrolytes used in batteries can be used, the electrolytes including a solid electrolyte as a lithium ion conductor, a gelatinous electrolyte, and a molten salt.

At least one of such supporting electrolyte salts can be dissolved in at least one of such nonaqueous solvents to produce an electrolytic solution (an organic electrolytic solution).

### <Method of Manufacturing Lithium-Ion Secondary Battery>

In a method of manufacturing the lithium-ion secondary battery according to the present invention, a step of fabricating the negative electrode is divided into the following three steps except the trimming step and the slitting step, as described above.

(i) A slurry preparation corresponds to a step of preparing a slurry for forming the negative-electrode mixture layer. (ii) A slurry application corresponds to a step of applying the slurry for forming the negative-electrode mixture layer onto the negative-electrode collector, and drying a solvent. (iii) A hot-roll press step corresponds to a compression molding step of compression-molding the negative-electrode collector and the negative-electrode mixture layer.

Such steps (i) to (iii) are now described.

### (i) Preparation of Negative-Electrode Slurry

The negative-electrode slurry is prepared to form the negative-electrode mixture layer according to the present invention. The negative-electrode active material, the binder and the solvent are preferably mixed using a planetary mixer.

Although N-methyl-2-pyrrolidone (NMP) is preferably used as the solvent of the negative-electrode slurry, another binder may be used.

A solid content percentage of the negative-electrode slurry is preferably 60 to 90%. The solid content percentage is a value defined by the following Formula (1).

Solid content percentage(%)=((mass of negative-electrode active material, binder and conductive agent)/(mass of negative-electrode active material, binder and conductive agent+mass of solvent))×100 (1)

A viscosity of the slurry for forming the negative-electrode mixture layer is desirably within a range from 3000 to 10000 mPa. The viscosity is a value measured after a lapse of 600 seconds from start of stirring at 0.5 rpm.

### (ii) Slurry Application

The slurry application is a step of applying the slurry for forming the mixture layer onto the current collector, and drying the slurry. An apparatus usable for such application includes a comma coater and a die coater.

The application amount of the slurry for forming the negative-electrode mixture layer is preferably 10 to 120 g/m² on one side, though it is not limited thereto. For the application amount of less than 10 g/m², the negative-electrode mixture layer is difficult to be formed. For the application amount of 120 g/m² or more, the binder is less likely to be thermally cured in the hot-roll press step of the present invention, and thus binding performance is degraded, leading to a slight degradation in the cycle characteristics.

The negative-electrode collector is preferably formed of copper or stainless steel (SUS). The SUS has an oxide film thereon at a normal temperature, and is therefore not increased in resistance due to an oxidation during the hot-roll press step. Furthermore, the SUS has a low specific gravity and a high strength, and effectively increases a cycle life. On the other hand, copper is preferred in light of cost.

In the application step, the slurry is dried at 80 to 120° C. in order to remove the solvent to fix the slurry to some degree. The drying temperature in the application step of the present invention is further desirably 90 to 110° C. in order to make distribution and thickness of the binder to be uniform, though the range of the drying temperature is not definite.

(iii) Hot-Roll Press Step

The current collector coated with the slurry as described above is compression-molded (pressed) to produce the negative electrode. As described above, the present invention uses the apparatus of FIG. 4A or 4B including a hot-roll press machine capable of controlling temperature of the hot-press roller within a range from 200 to 400° C. The temperature of the negative-electrode mixture in the hot-roll press step is desirably 150 to 300° C. In some case, the negative-electrode mixture is not heated to the temperature equal to the temperature of the hot-press roller due to a high press speed, low ambient temperature, or the like. The upper limit of the temperature of the hot-press roller is therefore defined to be the temperature of the negative-electrode mixture plus 100° C.

Furthermore, when a copper foil is used as the negative-electrode collector, the thermal curing is desirably performed under non-oxygen atmosphere as described before. In such a case, the nitrogen substitution box 6 (non-oxygen gas substitution chamber) as shown in FIG. 4B must be used in order to provide the non-oxygen atmosphere. When a SUS foil is used, the problem of oxidation does not occur because the SUS foil originally has an oxide film on its surface. Hence, the nitrogen substitution box is not necessary. The non-oxygen atmosphere refers to gas atmosphere having an oxygen content lower than that of the air. Examples of such a gas include a gas containing nitrogen, argon or the like as a main component.

The oxidation of the copper foil causes increase in the resistance (DCR). Hence, the cooling rollers 7 as illustrated in FIG. 4B are provided after the hot-roll press at 150 to 300° C. The negative electrode must be cooled before being exposed to the air in order to prevent the oxidation. As generally known, the temperature of the copper foil of 150° C. or lower prevents an increase in the DCR due to the oxidation. When the load of the hot-press roller exerted on the negative electrode is 1 to 50 kg/cm² though the load is not limited thereto, a density thereof is easily adjusted.

The speed of the hot-roll press is desirably 50 m/min or less though it is not limited thereto. If the speed is higher than 50 m/min, the binder is less likely to be thermally cured, and consequently an increase in the DCR or degradation in the cycle characteristics may be caused. The speed of the hot-roll press refers to a moving speed of the negative-electrode collector coated with the negative-electrode mixture slurry in the hot-roll press step.

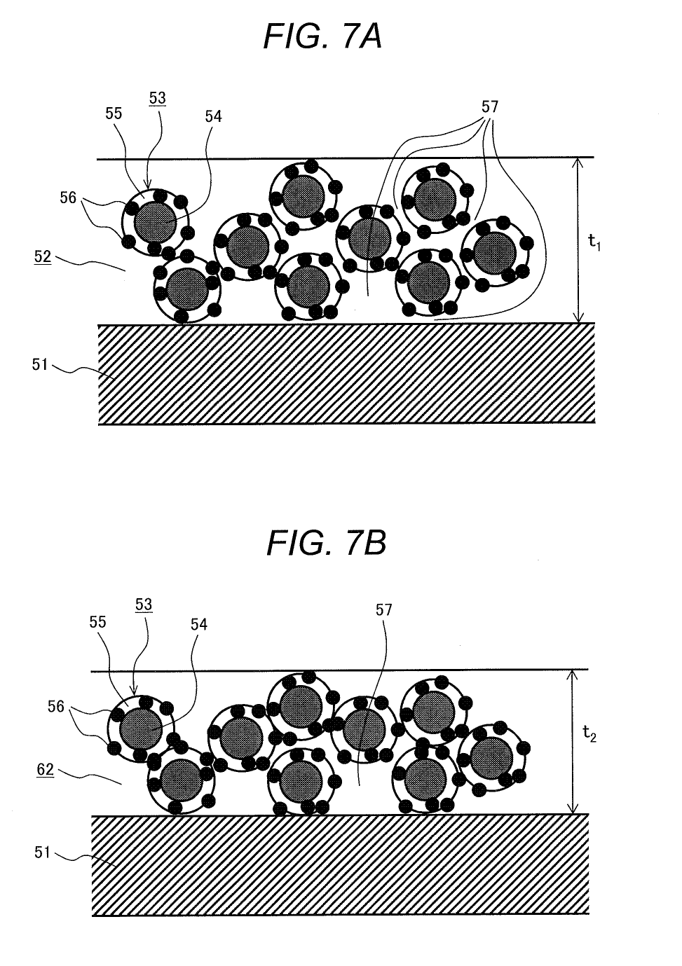

FIG. 7A is an expanded schematic sectional view illustrating an existing negative electrode which includes a polyimide-based binder the negative electrode being for a lithium-ion secondary battery.

In FIG. 7A, a negative-electrode mixture layer 52 is provided on a surface of a negative-electrode collector 51. The negative-electrode mixture layer 52 includes solid particles 53. The solid particles 53 are each composed of a negative-electrode active material 54, a binder 55 and a conductive agent 56. The solid particles 53 have a space 57 therebetween.

The thickness of the negative-electrode mixture layer 52 is denoted as t₁. A porosity of the negative-electrode mixture layer 52 is 40 to 60%, the porosity referring to a percentage of the spaces 57 in the negative-electrode mixture layer 52.

As illustrated in FIG. 7A, the solid particles 53 are away from the negative-electrode collector 51 at a high possibility, and the adjacent solid particles 53 are likely to have a space therebetween. This is possibly because the negative-electrode mixture layer 52 is heated to a relatively low temperature of 100 to 120° C. by the hot-roll press, and is separately subjected to the thermal curing; hence, the negative-electrode mixture layer 52 is expanded in volume during the thermal curing, and is thus insufficiently pressed.

FIG. 7B is an expanded schematic sectional view illustrating a negative electrode of the present invention for a lithium-ion secondary battery.

In FIG. 7B, a negative-electrode mixture layer 62 is provided on a surface of the negative-electrode collector 51. The negative-electrode mixture layer 62 includes the solid particles 53. The solid particles 53 are each composed of the negative-electrode active material 54, the binder 55 and the conductive agent 56. The solid particles 53 have a space 57 therebetween.

The thickness of the negative-electrode mixture layer 62 is denoted as t₂. The porosity of the negative-electrode mixture layer 62 is 20 to 40%, the porosity referring to a percentage of the spaces 57 in the negative-electrode mixture layer 62. Hence, t₂ is smaller than t₁ The porosity is more desirably 20 to 30%.

As illustrated in FIG. 7B, the solid particles 53 are each in close contact with the negative-electrode collector 51 at a high possibility, and the adjacent solid particles 53 are less likely to have a space therebetween. This is possibly because the negative-electrode mixture layer 62 is heated to a high temperature of 150 to 300° C. by the hot-roll press, so that press and the thermal curing are sufficiently performed together.

The negative electrode illustrated in FIG. 7B is less likely to occur separation because of a strong adhesiveness of the binder. Consequently, a battery including the negative electrode can be decreased in the direct-current resistance (DCR) and increased in the cycle life. In addition, since the negative electrode can be decreased in thickness, it is possible to increase the amount of the active material in the laminated electrode group, and is thus possible to fabricate a battery having a large capacity despite having a compact size.

### EXAMPLES

Although the present invention is now described in detail with reference to examples, the present invention should not be limited thereto. In each of the examples, the negative electrode was fabricated in a roll.

### (1) Fabrication of Negative Electrode for Lithium-Ion Secondary Battery of Each of Examples 1 to 13 and Comparative Examples 1 to 5

### (1-1) Preparation of Negative-Electrode Slurry of Example 1

A negative-electrode active material, a conductive agent, a binder and a solvent were mixed to prepare a negative-electrode slurry.

A mixture of SiO and graphite (C) in a ratio of 50:50 by mass percent was prepared as the negative-electrode active material. PAI and PI were prepared as the binder. Acetylene black was prepared as the conductive agent.

The mass ratio of the negative-electrode active material to the binder and the conductive agent was 92:5:3. The slurry was prepared using a planetary mixer while NMP was mixed therein such that viscosity of the slurry was 5000 to 8000 mPa and a solid content percentage was 70% or more and 90% or less.

### (1-2) Preparation of Negative-Electrode Slurries of Examples 2 to 6

Negative-electrode slurries of examples 2 to 6 were prepared, the slurries having different compositions from one another. In the examples 2 and 3, an Si alloy (Si-iron (Fe) alloy) or an Sn alloy (Sn-nickel (Ni) alloy) was used in place of the SiO as the negative-electrode active material. In each of the examples 4 to 6, PI, PA, or a mixture of PAI and PVDF was used in place of PAI as the binder.

### (1-3) Application of Negative-Electrode Slurry and Compression Molding with Hot-Roll Press Machine

The negative electrodes of the examples 1 to 6 were each fabricated as follows:

A copper foil was used as the negative-electrode collector, and the negative-electrode slurry was applied onto the negative-electrode collector and dried, and then such a copper foil with the slurry was compression-molded by the hot-roll press machine under a nitrogen atmosphere so as to be formed into the negative electrode.

A desktop comma coater (from THANK-METAL) was used for the application. The application amount was 60 g/m². The drying was performed using a drying oven for about 1 min at 100° C. The hot-roll press was performed at the hot-press roller load of 15 kg/cm². The temperature of the hot-press roller was 300° C., and the press speed was 5 m/min.

The compression molding increases density of the negative-electrode mixture layer. In other words, the percentage of spaces (porosity) in the negative-electrode mixture layer is about 20 to 40% in the examples 2 to 6. The negative electrode including the SiO active material was pressed into a density of 1.3 to 1.5 g/cm³, and the negative electrode including the Si alloy was pressed into a density of 2.0 to 2.4 g/cm³.

### (1-4) Fabrication of Negative-Electrode for Lithium-Ion Secondary Battery of Each of Examples 7 to 13

Negative electrodes of examples 7 to 13 were fabricated using a negative-electrode slurry similar to that of the example 1 under various fabrication conditions. In the example 7, a SUS foil was used in place of the copper foil as the negative-electrode collector of the example 1. In the example 8, the application amount of the negative-electrode mixture of the example 1 was 120 g/m². In the examples 9 and 10, temperature of the hot-press roller was varied to 200° C. and 400° C., respectively. In the example 11, the hot-roll press was performed in the air. In the example 12, the negative-electrode collector of the example 11 was changed from the copper foil to a SUS foil. In the example 13, the press speed was increased to 50 m/min.

### (2) Fabrication of Negative Electrode for Lithium-Ion Secondary Battery of Each of Comparative Examples 1 to 5

In the comparative example 1, the negative electrode is thermally cured while being wound in a roll according to the fabrication procedure illustrated in FIG. 2. The same negative-electrode slurry as that of the example 1 was prepared, and applied onto the negative-electrode collector including a copper foil and dried, and was then subjected to the hot-roll press at 120° C. The pressed negative electrode was wound into a roll, and was then dried for 1 hour by a vacuum drier at 300° C.

In the comparative example 2, the negative electrode was subjected to the hot-roll press step at 120° C. as with the comparative example 1, and was then slit into sheets and then vacuum-dried at 300° C. Hence, the negative electrode was thermally cured while being placed in a form of flat sheets in a vacuum drier. In the comparative example 3, the negative electrode was subjected to the hot-roll press as with the comparative example 1, but was not subsequently thermally cured by the vacuum drier. In the comparative example 4, a polyimide was used as the binder In the comparative example 5, a polyamide was used as the binder.

The composition of the negative-electrode slurry and the fabrication condition of the negative electrode of each of the examples and the comparative examples are as shown in Table 1.

TABLE 1

| | Negative- | Negative- | Negative- | Application amount of | Hot-roll press | Hot-roll | Hot-roll | |
|---|---|---|---|---|---|---|---|---|
| | electrode | electrode | electrode | negative-electrode | temperature | press | press speed | Vacuum |
| | active material | binder | collector | slurry (g/m²) | (° C.) | atmosphere | (m/min) | dryer |
| Example 1 | SiO + graphite | PAI | Cu | 60 | 300 | Nitrogen | 5 | Not used |
| | (50:50 wt %) | | | | | | | |
| Example 2 | Si alloy + graphite | PAI | Cu | 60 | 300 | Nitrogen | 5 | Not used |
| | (50:50 wt %) | | | | | | | |
| Example 3 | Sn alloy + graphite | PAI | Cu | 60 | 300 | Nitrogen | 5 | Not used |
| | (50:50 wt %) | | | | | | | |
| Example 4 | SiO + graphite | PI | Cu | 60 | 300 | Nitrogen | 5 | Not used |
| | (50:50 wt %) | | | | | | | |
| Example 5 | SiO + graphite | PA | Cu | 60 | 300 | Nitrogen | 5 | Not used |
| | (50:50 wt %) | | | | | | | |
| Example 6 | SiO + graphite | PAI + PVDF | Cu | 60 | 300 | Nitrogen | 5 | Not used |
| | (50:50 wt %) | (70:30 wt %) | | | | | | |
| Example 7 | SiO + graphite | PAI | SUS | 60 | 300 | Nitrogen | 5 | Not used |
| | (50:50 wt %) | | | | | | | |
| Example 8 | SiO + graphite | PAI | Cu | 120 | 300 | Nitrogen | 5 | Not used |
| | (50:50 wt %) | | | | | | | |
| Example 9 | SiO + graphite | PAI | Cu | 60 | 200 | Nitrogen | 5 | Not used |
| | (50:50 wt %) | | | | | | | |
| Example 10 | SiO + graphite | PAI | Cu | 60 | 400 | Nitrogen | 5 | Not used |
| | (50:50 wt %) | | | | | | | |
| Example 11 | SiO + graphite | PAI | Cu | 60 | 300 | Air | 5 | Not used |
| | (50:50wt %) | | | | | | | |
| Example 12 | SiO + graphite | PAI | SUS | 60 | 300 | Air | 5 | Not used |
| | (50:50 wt %) | | | | | | | |
| Example 13 | SiO + graphite | PAI | Cu | 60 | 300 | Nitrogen | 50 | Not used |
| | (50:50 wt %) | | | | | | | |
| Comparative | SiO + graphite | PAI | Cu | 60 | 120 | Nitrogen | 5 | Used |
| example 1 | (50:50 wt %) | | | | | | | (in roll) |
| Comparative | SiO + graphite | PAI | Cu | 60 | 120 | Nitrogen | 5 | Used |
| example 2 | (50:50 wt %) | | | | | | | (in sheets) |
| Comparative | SiO + graphite | PAI | Cu | 60 | 120 | Nitrogen | 5 | Not used |
| example 3 | (50:50 wt %) | | | | | | | |
| Comparative | SiO + graphite | PI | Cu | 60 | 120 | Nitrogen | 5 | Used |
| example 4 | (50:50 wt %) | | | | | | | (in roll) |
| Comparative | SiO + graphite | PA | Cu | 60 | 120 | Nitrogen | 5 | Used |
| example 5 | (50:50 wt %) | | | | | | | (in roll) |

### (3) Fabrication of Positive Electrode

The positive electrode was fabricated as follows:

An aluminum foil was prepared as a positive-electrode collector, and a slurry for forming a positive-electrode mixture layer was applied onto the aluminum foil and dried, the slurry containing a positive-electrode active material, a binder and a solvent, and then such an aluminum foil with the slurry was compression-molded into the positive electrode.

LiNi_{0.8}Mn_{0.1}Co_{0.1}O₂ was used as the positive-electrode active material, PVDF was used as the binder, and NMP was used as the solvent. Furthermore, a carbon material was added as a conductive agent into the positive-electrode slurry. A mass ratio of the positive-electrode active material to the binder and the conductive agent was 90:5:5. The application amount of the slurry for forming the positive-electrode mixture layer was adjusted such that a volume ratio with respect to the negative electrode was 1.0. The compression molding was performed such that the positive electrode had a density of 2.8 g/cm³.

### (4) Fabrication of Test Cell (Laminated Cell)

The positive and negative electrodes fabricated as described above were used to fabricate a test cell of the lithium-ion secondary battery as illustrated in FIGS. 5 and 6.

The respective uncoated positive-electrode portions and uncoated negative-electrode portions are bundled and welded to the positive-electrode terminal and the negative-electrode terminal that electrically connect between the inside and the outside of the battery, respectively. A resistance welding was used as the welding method. A solution was used as an electrolytic solution, the solution including a supporting electrolyte salt of 1M LiPF₅ dissolved in a solvent of ethylene carbonate (EC): ethyl methyl carbonate (EMC)=1:3 (vol %). After an injection of the electrolytic solution, the peripheries of laminating films were sealed by a thermal fusing, and the positive electrode and the negative electrode were each allowed to penetrate the sealed films while being electrically isolated from each other, so that the test cells were fabricated. The sealing by the thermal fusing was performed by holding the laminating films at 175° C. for 10 seconds.

### (Evaluation)

The lithium-ion secondary batteries of the examples 1 to 12 and the comparative examples 1 to 4 fabricated as above were subjected to the following evaluation.

### (1) Determination of Presence of Separation

A separation between the negative-electrode collector and the negative-electrode mixture layer was visibly checked for each of the fabricated negative electrodes.

Results are shown in Table 2.

### (2) Measurement of Thickness Difference in Width Direction (Maximum Variation Value of Thickness of Negative-Electrode Mixture Layer)

A thickness difference in a width direction of the negative-electrode mixture layer was measured using a thickness gauge (Rotary Caliper Gauge RC-1, from Maysun Corporation). Results are collectively shown in Table 2.

### (3) Evaluation of DCR of Laminated Cell

The fabricated laminated cell was subjected to a constant-current charge at a voltage of 4.2 V and a current of ⅓ CA, and was then subjected to a constant-voltage charge for two hours. The laminated cell was then subjected to a constant-current discharge at a voltage of 2.5 V and a current of ⅓ CA. Subsequently, the laminated cell was charged in the above-described manner, and the DCR was measured. The DCR was calculated as follows:

The laminated cell was discharged for 10 seconds at a current of 5 CA from a voltage of 4.2 V, and a quotient of a voltage variation during such discharge divided by the current of 5 CA was obtained as the DCR. These results are collectively shown in Table 2.

### (4) Cycle Evaluation of Laminated Cell

The fabricated laminated cell was subjected to the constant-current charge at a voltage of 4.2 V and a current of ⅓ CA, and was then subjected to the constant-voltage charge for two hours. The laminated cell was then subjected to the constant-current discharge at a voltage of 2.5 V and a current of ⅓ CA. The capacity maintenance factor was calculated as follows:

Such charge and discharge were repeated 100 cycles, and a discharged capacity at the 100^{th} cycle was divided by a discharged capacity at the first cycle, and the obtained quotient was defined as a capacity maintenance factor. These results are collectively shown in Table 2.

TABLE 2

| | | Thickness | | Capacity |
|---|---|---|---|---|
| | | difference | DCR | maintenance |
| | Separation | (μm) | (Ω) | factor (%) |
| Example 1 | Absent | 3 | 0.3 | 70 |
| Example 2 | Absent | 3 | 0.3 | 70 |
| Example 3 | Absent | 3 | 0.4 | 60 |
| Example 4 | Absent | 3 | 0.3 | 70 |
| Example 5 | Absent | 3 | 0.3 | 70 |
| Example 6 | Absent | 3 | 0.3 | 70 |
| Example 7 | Absent | 3 | 0.4 | 70 |
| Example 8 | Absent | 3 | 0.4 | 60 |
| Example 9 | Absent | 3 | 0.4 | 60 |
| Example 10 | Absent | 3 | 0.3 | 70 |
| Example 11 | Absent | 3 | 1 | 40 |
| Example 12 | Absent | 3 | 0.4 | 70 |
| Example 13 | Absent | 3 | 0.3 | 70 |
| Comparative | Present | 10 | 2 | 20 |
| example 1 | | | | |
| Comparative | Absent | 5 | 0.4 | 60 |
| example 2 | | | | |
| Comparative | Absent | 3 | 1 | 20 |
| example 3 | | | | |
| Comparative | Present | 10 | 2 | 20 |
| example 4 | | | | |
| Comparative | Present | 10 | 2 | 20 |
| example 5 | | | | |

As illustrated in Table 2, the negative-electrode mixture layer was not separated from the negative-electrode collector, and the difference in the thickness in the width direction of the negative-electrode mixture layer was 3 μm or less, showing a sufficiently small variation in thickness in each of the examples 1 to 13. In addition, the DCR was low, and the capacity maintenance factor after 100 cycles was improved.

In the example 8, the application amount was larger (1.5 times) than in the example 1; hence, the DCR characteristics and the cycle characteristics were each rather low, but high capacity was obtained.

In the example 11, the hot-roll press was performed in the air, thereby the copper foil collector was oxidized, and the DCR was increased. Furthermore, a binding performance was degraded during the cycles by the oxidation, and thereby the cycle characteristics were possibly degraded. It is therefore preferred that when the negative electrode including the copper foil was subjected to the hot-roll press in the air, the oxidation is suppressed by decreasing a processing time, for example, through increasing a processing speed. As shown in the example 12, the SUS that is less oxidized is used as the negative-electrode collector, thereby the oxidation is suppressed even if the hot-roll press is performed in the air, and the DCR of 0.4Ω and the capacity maintenance factor of 70% can be obtained as with the example 7 in which the hot-roll press is performed in the nitrogen atmosphere.

In contrast, in the comparative example 1, since the negative electrode was dried (at 300° C.) in the vacuum while being wound in a roll, the binder was cured in a roll, and when the negative-electrode roll was stretched, the negative-electrode mixture layer was separated from the current collector. As a result, the thickness difference was large, the DCR was high, and the capacity maintenance factor was low.

In the comparative example 2, the negative electrode was subjected to the hot-roll press at 120° C. and then slit into the sheets, and was then vacuum-dried at 300° C. This resulted in a spring back or temperature unevenness, leading to a slight variation in the thickness compared with each example. This possibly caused a slight degradation in the DCR characteristics and in the cycle characteristics.

In the comparative example 3, since the thermal curing step itself was not performed, the binding force was weak, and consequently a conductive network was weakened, possibly causing the increase in the DCR and the degradation in the cycle characteristics.

### (5) Peel Strength Test

A peel strength was compared between the case of performing the press step and the thermal curing together and the case of separately performing the press step and the thermal curing. The peel strength test was performed in an electrode area of 2 cm² in accordance with JIS K5600-5-6 (a cross-cut method).

As a result of the peel strength test, the following peel strength was given for each case.

(a) The press by the hot-press roller at 120° C. followed by the thermal curing at 300° C.: 1 to 0.5 N.

(b) The simultaneous press and thermal curing by the hot-press roller at 300° C.: 1 to 3 N.

As described above, according to the present invention, the reduction in each of the adhesiveness and the adhesion uniformity of the binder due to the temperature variations can be suppressed. Consequently, it is possible to decrease the direct-current resistance (DCR) of the lithium-ion secondary battery, and increase a cycle life thereof.

Furthermore, according to the present invention, since the thermal curing and the press are performed together in the fabrication process of the negative electrode for the lithium-ion secondary battery, the negative electrode can be thermally cured by the roll-to-roll process. Consequently, mass-productivity can be improved, and a manufacturing facility can be simplified.

The aforementioned embodiment and examples have been described to help understanding of the present invention, and the present invention is not limited to the described specific configurations. For example, part of a configuration of an example may be replaced with a configuration of another example Furthermore, a configuration of an example may be additionally provided with a configuration of another Example. In other words, in the present invention, part of a configuration of each of the embodiment and the examples of the specification may be omitted, additionally provided with a configuration of another example, or replaced with a configuration of another example.

What is claimed is:

1. A method of manufacturing a negative electrode for a lithium-ion secondary battery,
the negative electrode which includes:
a negative-electrode mixture layer including a negative-electrode active material and a binder containing at least one selected from a group consisting of a polyimide, a polyamide-imide and a polyamide; and
a negative-electrode collector,
the method comprising the steps of:
an applying step of applying a negative-electrode mixture slurry including the binder and the negative-electrode active material onto a surface of the negative-electrode collector; and
a hot-roll press step of performing a pressing by a heated hot-press roller such that a temperature of the negative-electrode collector coated with the negative-electrode mixture slurry is 150 to 300° C.

2. The method according to claim 1,
wherein the pressing in the hot-roll press step is performed such that the temperature of the negative-electrode collector coated with the negative-electrode mixture slurry is 200 to 300° C.

3. The method according to claim 1,
wherein a temperature of the hot-press roller in the hot-roll press step is 200 to 400° C.

4. The method according to claim 1,
wherein the hot-roll press step is performed under an air atmosphere or a non-oxygen atmosphere.

5. The method according to claim 1,
further comprising a cooling step of cooling the negative-electrode collector after the hot-roll press step.

6. The method according to claim 5,
wherein the cooling step is a step of controlling the temperature of the negative-electrode collector to be 150° C. or lower.

7. The method according to claim 6,
wherein the hot-roll press step and the cooling step are performed under a non-oxygen atmosphere.

8. The method according to claim 7,
wherein the non-oxygen atmosphere is one of a nitrogen atmosphere and a vacuum.

9. The method according to claim 1,
wherein the negative-electrode collector is formed of one of a copper alloy and stainless steel.

10. The method according to claim 1,
wherein a press pressure in the hot-roll press step is 1 to 50 kg/cm².

11. The method according to claim 1,
wherein the negative-electrode collector is pressed at a processing speed of 50 m/min or less in the hot-roll press step.

12. The method according to claim 1,
wherein the negative-electrode mixture slurry contains N-methyl-2-pyrrolidone.

13. The method according to claim 1,
wherein an application amount of the negative-electrode mixture slurry is 10 to 120 g/m² on one side of the negative-electrode collector.

14. The method according to claim 1,
further comprising a drying step of drying the negative-electrode mixture slurry at 80 to 120° C. after the applying step and before the hot-roll press step.

15. A negative electrode for a lithium-ion secondary battery, the negative electrode comprising:
a negative-electrode mixture layer including a negative-electrode active material, and a binder containing at least one selected from a group consisting of a polyimide, a polyamide-imide and a polyamide; and
a negative-electrode collector,
wherein the negative electrode is manufactured by the method according to claim 1.

16. The negative electrode according to claim 15,
wherein the negative-electrode active material contains one of Si and Sn.

17. The negative electrode according to claim 15,
wherein the negative-electrode mixture layer has a porosity of 20 to 40%.

18. A lithium-ion secondary battery comprising:
a positive electrode;
the negative electrode according to claim 17;
a separator; and
an electrolyte.

19. An apparatus for manufacturing a negative electrode for a lithium-ion secondary battery, the negative electrode including a negative-electrode mixture layer and a negative-electrode collector,
the apparatus comprising:
a hot-press roller that performs a hot-roll pressing on the negative-electrode collector with the negative-electrode mixture layer such that the negative-electrode collector has a temperature of 150 to 300° C.

20. The apparatus according to claim 19,
further comprising a non-oxygen gas substitution chamber for placing the hot-press roller in non-oxygen atmosphere.

21. The apparatus according to claim 20,
further comprising a cooling roller that cools the negative-electrode collector subjected to the hot-roll pressing.
